(19) United States
(12) Patent Application Publication
(10) Pub. No.: US 2024/0180169 A1
(43) Pub. Date: Jun. 6, 2024

(54) PASTRY MAKING MACHINE

(71) Applicant: Mikhail V. Sorokin, Volgograd (RU)

(72) Inventor: Mikhail V. Sorokin, Volgograd (RU)

(21) Appl. No.: 18/282,529

(22) PCT Filed: Mar. 10, 2022
(86) PCT No.: PCT/RU2022/000069

§ 371 Date: Sep. 16, 2023

(30) Foreign Application Priority Data
Mar. 16, 2021 (RU) 2021106975

(51) Int. Cl. A21B 1/42

(52) U.S. Cl. CPC A21B 1/42

(57) ABSTRACT

A pastry making machine comprises a conveyor with product molds on the matrices. Stamps are adapted to cover matrices. A dough dispenser with a hopper is installed at the beginning of the conveyor. There are also an oven, a product unloader, a blower with rolls, a manipulator equipped with a lifting mechanism and magnetic or mechanical grippers for the stamps, and a control unit. The surface of the rolls is profiled with separating cells forming longitudinal and transversal rows. The dosing head has at least one row of separating chambers, with channels discharging dosed dough pieces. An induction heating assembly is positioned along the oven. Each matrix is mounted on a wheeled cart, attached to the conveyor. One embodiment has a current-conductive profile connected to the heating assemblies of the stamps. Another embodiment has its heating assembly stretched alongside the whole oven heating the stamps and matrices. The machine improves product quality.

The invention relates to food industry, and more specifically, to a machine that can be used for making pastry products such as tart shells, waffles, or walnut-shaped cookies.

Prior Russian Federation Patent No. 115623 for the utility model “Pastry making machine”, IPC A21B 5/02, issued May 10, 2012, discloses a pastry making machine comprising an automatic dispenser and an oven; a belt conveyor and molds are positioned inside the oven; driving and following pulleys connect the conveyor with a support frame. The automatic dispenser is mounted on a support and consists of a hopper, a screw, and a dosing head; the hopper is equipped with a feeding screw. The molds made of food-grade metal sheets are installed on a module comprising a stamp and a matrix. The molds may be covered with an anti-stick surface and have the geometric shape of the pastry products; for shaping the products, the molds are secured in a closed position throughout the baking process. When the belt with the molds is in motion, the matrices and stamps get opened and closed via closing and opening devices. The automated dispenser is synchronized with the belt motion via the sensor that ensures the right positioning of the dosed dough pieces when they are being discharged to the open molds from the hopper. The unloader provides smooth removal of the finished product from the molds and its transportation from the oven. The machine is capable of working in an automated mode; in this mode, belt and dispenser screw rotation and the preset temperature are automatically controlled. The control panel has a limited number of preset parameters, i.e., baking time and dosed dough pieces size; these parameters are sufficient for selecting the right mode in case dough parameters are changed.

The drawbacks of that patented pastry making machine include its high temperature delay (i.e., long pre-launch heating and long cooldown), the excessively complex design of shaping devices mounted on the module that comprises the stamp and the matrix, as well as the fact that the molds contact the friction elements while being intensively heated during the baking process. Besides, the belt conveyor is constantly heated when positioned inside the oven; the high temperature of metal parts and nodes makes it impossible to grease the points of friction, thus limiting the conveyor's life of service. Opening and upturning the molds may not remove the product from the mold, especially in the case of intricately shaped pastry. The design description does not specify the process of collecting excessive fat that has been formed during the baking process. Unremoved fat may damage heating assemblies and affect the functional reliability of the machine.

Another prior patent (RU No. 2504155 IPC A21B 1/48, issued Jan. 20, 2014) discloses the oven comprising the loading station, the baking chamber, and the unloading station. Besides, its design includes metal plates with the mounted molds (their motion trajectory includes the baking chamber), and the conveyor transporting the molds. The metal plates and the molds are designed as current collectors and provide contact-free induction heating. The baking chamber is equipped with an induction heater. The heater has at least one oblong inductor positioned parallel to the metal plate trajectory and along the trajectory of several current-collecting plates. The oblong inductor creates a large magnetic field enabling the contact-free induction heating of several metal current-collecting plates.

The drawbacks of said patented oven include its ineffective use of the electromagnetic field generated around the inductors and its unsafe induction, as the open high-voltage radiators are not protected from the excessive fat dripping during the baking process. The lower part of the plates and the molds get heated, as well as any other metal parts within a 10-cm distance: the chain, wheels, connectors, guide rails, supports, inductors. Although the induction radiation is partially pulled to the plates, the rest of it spreads to adjacent elements not involved in the baking process directly. The oven description does not specify how the issue of self-induction heating of the inductor is addressed. According to the drawings demonstrating the inductor layout options, the inductor can be made of a wire, a cable, or a tube. However, long distances between the inductor turns (rods) that are mounted onto special supports indicate that the oven uses low-efficiency air-cooled radiators.

Another prior patent, RU No. 2565269, IPC A21B 5/02, issued Oct. 10, 2015, discloses a dough dispenser and the pastry machine variants (prototype). One said variant comprises the dough dispenser, a support frame, a chain conveyor, a baking oven, and a finished product unloader; the dough dispenser consists of a support, a hopper, a blower, a dosing head and a device discharging dosed dough pieces. The hopper and the blower are attached to a dosing head case; the blower consists of rolls forming a kinematic pair; there is a gap between each of the rolls and the dosing head surface. Cylinder surfaces of the rolls are profiled with separating cells spaced from each other and forming longitudinal and transversal rows. Similar to longitudinal rows of separating cells of the blower rolls, the dosing head surface has the rows of separating chambers arranged in rows. In general, the rolls are positioned to cover the separating chambers from both sides. A device discharging the dosed dough pieces is installed in the lower part of the dispenser and has the molding plate with calibrating channels (channels discharging dosed dough pieces) joined with the separating chambers of the dosing head; the device also has cutting plates capable of reciprocal motion relative to one another for cutting the dosed dough pieces. The transporter is equipped with the carts for the matrices; every cart has an integral base with a matrix and the molds mounted on top of it and front and back wheeled axles installed underneath the base. The carts are attached to the chain conveyor with the end parts of their front axles and can be upturned. The machine has the open conveyor oven, equipped with the shaping matrices moving in the direction of travel of the conveyor line; above the matrices, there are stamps capable of upward and downward vertical motion. The stamps are stationary relative to the conveyor's support frame. The matrices with the molds on the conveyor, as well as the stamps above the matrices, are equipped with the heating elements. A supporting bar is attached to the support frame; this bar is positioned along the conveyor and has current-conducting profiles on its top and bottom parts isolated from each other. The heating element of each matrix is equipped with the current-collecting contact connected to a respective current-conducting profile. Every stamp is equipped with an individual pneumatic drive and can be connected either to the drive's cylinder shaft or to a beam attached to the cylinder shaft. The pneumatic drives are mounted on the stands connected to the conveyor's support frame. The finished product unloader is equipped with the cart upturning limiter, designed as the console installed on the conveyor's support frame. The machine has the control unit with sensors connecting it to the dispenser, chain conveyor drive, pneumatic drives of the stamps, heating elements of matrices and stamps. The motion of the dispenser carriage is regulated according to the position of molds on the matrices and each matrix. The known pastry making machine is equipped with the open electrically heated conveyor oven. Thus, the conveyor's support frame has the supporting bar attached to it, with current-conducting profiles above and underneath thereof isolated from each other. Each respective current-conducting profile is connected to a current-collecting contact of the heating element; this design solution is applied to every matrix transported by the conveyor.

According to the design, each stamp is mounted on the support stand attached to the conveyor's support frame; when the oven is active, each stamp moves downwards to the heated matrix via its individual pneumatic drive. If the matrices and the stamps are equipped with spiral heating elements or resistance elements, then heating up the oven becomes a time-consuming process leading to heat losses, as heat parameters of the known machine greatly exceed the temperature mode required for baking)(˜180°. For instance, heat energy dissipates when the bases of the carts, on which matrices with molds are installed, are being heated. The cart bases must be heated up to at least 300°, because positioned underneath the base of every cart is the matrix heating element, and the matrix is heated by the cart base like an electric hot plate. For baking pastry products, the molds on the matrices must be greased with fat; when the stamps contact the heated matrices, the fat may not only flow onto the matrix surface but also get beyond it. Hot fat may cause sparks or even a fire in case it reaches the sliding current-collecting contacts of the heating elements. Other drawbacks of that machine include the friction wear of mechanical parts (e.g., uneven wear of dispenser roll surface, wear of carts with matrices that are wheeled along the conveyor, wear of the beams moving the stamps up and down, etc.), the large number of mobile mechanical parts, design complexity, and size parameters.

The purpose of the proposed group of inventions is to design the pastry making machine that would ensure operational stability and effective performance while reducing operational resource consumption and providing the high quality of finished products.

The technical result aims to improve the reliability and performance of the machine, as well as to simplify its design and make it more compact.

The pastry making machine (variant 1) achieves these aims; the machine comprises a batch dispenser installed on a frame capable of reciprocal motion, a transporter attached to a support frame—the chain conveyor with molds located in longitudinal rows on the matrices, a stamps positioned according to the rows of molds on the matrices, a open conveyor oven for baking, a finished product unloader, and a control unit connected with sensors to the dispenser and a conveyor drive. In the dispenser, a hopper is attached to a dosing head case, a blower consists of rolls forming at least one kinematic pair; surfaces of the rolls are profiled with separating cells spaced from each other and forming longitudinal and transversal rows. ccording to those rows, the dosing head has rows of separating chambers joined with channels discharging dosed dough pieces. The matrices and the stamps (mounted on the conveyor, installed in the open oven area, with the stamps capable of vertical motion for covering/uncovering the matrices) are equipped with heating assemblies located above and underneath the conveyor respectively and connected to the control unit. Every matrix is mounted on an integral base of a wheeled cart attached to the chain conveyor with end parts of its front axle for upturning the cart and unloading the finished product transported from the oven. According to the invention design, the machine has one heating assembly located in the oven underneath the conveyor, stretched along the oven and supported by brackets. Longitudinally set inside the heating assembly is a dielectric-insulated induction element—a coil with horizontally stretched turns, equipped with a water-cooling system. IT-shaped stands are installed above the conveyor in the oven area; their vertical elements are attached to the sides of the conveyor's support frame. Placed on II-stand bars are sliding rails with a platform, a supporting bar along the conveyor, and a current-conducting profile. The platform is capable of reciprocal motion along the sliding rails; the Clean copy of the specification external sides of the rails are equipped with flexible arms of tooth-belt transmissions. The platform is equipped with a manipulator with a lifting mechanism and magnetic or mechanical grippers for the stamps. Every stamp is equipped with a pressing roll mounted on a bracket attached to the supporting bar and with a current-collecting spring profile for connecting the heating assembly to the current-conducting profile. The manipulator motion cycle is performed under commands from the automated control unit.

One particular embodiment of the first variant of the machine has the induction element (the coil) equipped with the cooling system consisting of an upper and a lower contours; in each contour, a cooling pipe is positioned in turns similar to the induction element.

Another particular embodiment of the first variant has the induction element of the heating assembly made of a metal tube that forms inside the inner space a contour of the induction element's cooling system.

The pastry making machine (variant 2) also achieves the above aims comprises the dough dispenser installed on the frame capable of reciprocal motion, the transporter installed on the support frame and including the chain conveyor with the product molds, the stamps positioned according to the rows of the molds on the matrices, the open conveyor oven for the baking products, the finished product unloader and the control unit connected by sensors to the dispenser, and the conveyor drive. Meanwhile, the hopper of the dispenser is joined with the dosing head case, the blower consists of rolls forming at least one kinematic pair, with their surface profiled with separating cells spaced from each other and forming longitudinal and transversal rows. According to these rows of separating cells, the dosing head surface has rows of separating chambers joined with the channels discharging dosed dough pieces. The matrices and the stamps, installed in the open oven area, the stamps being capable of vertical motion for coupling/uncoupling with the matrices, are equipped with heating assemblies located above and underneath the conveyor respectively and connected to the control unit. Every matrix is mounted on the integral base of the wheeled cart, connected to the chain conveyor with the end parts of its front axle for upturning the cart and unloading the finished products transported from the oven.

According to the invention design, the described pastry making machine is equipped with heating assemblies for the oven; one unit is installed above the conveyor and the other—on the brackets below the conveyor, the units are stretched along the whole oven. Within every unit, there is the dielectric-insulated induction element (coil) with horizontally stretched turns; the element is equipped with the water-cooling system. The II-shaped stands are installed above the conveyor in the oven area; their vertical elements are attached to the sides of the conveyor's support frame. On the II-stand bars, there are the sliding rails with the platform, the supporting bars along the conveyor, and the induction unit attached between the bars. The platform is capable of reciprocal motion along the sliding rails; the external sides of the rails are equipped with flexible arms of tooth-belt transmissions. The platform has the manipulator mounted thereon and equipped with the lifting mechanism and magnetic or mechanical grippers for the stamps. Every stamp is equipped with the pressing rolls on the brackets to rest on the supporting bars; the manipulator motion cycle is performed under commands from the control unit.

In this embodiment of variant 2, the induction element (the coil) in any heating assembly of the oven is equipped with the cooling system consisting of the upper and lower contours; in each contour, the cooling pipe is positioned in turns similar to the induction element.

In another embodiment of this variant, the induction element of any heating assembly of the oven is made of a metal tube that forms inside the tube the internal contour of the induction element's cooling system.

In both embodiments of both variants, the dough dispenser, with each kinematic pair of the blower rolls having a separate drive, is installed on the conveyor support frame; the sliding rails are attached to the support frame to move the carriage with the dispenser.

In other embodiments of variants 1 and 2 of the machine, the base of every cart with the matrices, installed in the direction of travel of the conveyor, has T-shaped bent edges in the front and in the back; the axle with the wheels is installed under the bent part of the front edge.

In yet another (fifth) embodiment of both variants of the machine, it can be equipped with a finished product turner and an excess remover in front of the unloader.

A comparative analysis with the prototype demonstrates that variants 1 and 2 of the claimed machine differ from the prototype: the machine has the open induction conveyor oven, the stamps are installed so that they can be horizontally transported in relation to the matrices. The molds in the oven are heated contact-free via high-frequency current, with no sliding contacts; this prevents spark formation that, when dealing with heated fat, may cause inflammation of the oven. The high-frequency electromagnetic field (20-100 kHz) generated by the induction coil (inductor) has its maximum effect at a 15-mm (+/−5 mm) distance. The inductor is designed as a dielectric-insulated unit (coil) stretched along the whole oven, with its turns horizontally stretched, and equipped with a water-cooling system; it provides local heating of molds on the matrices, prevents unreasonable heat losses, and reduces power consumption. Turns of the induction element in the heating assembly are positioned as close to one another as possible, yet during the radiation, the self-induction may overheat the induction element causing bend deformation of the heating assembly. The water-cooling system of the heating assembly (coil) removes heat and prevent the unit from deformation. The changes in the stamp transportation simplify the design of the oven and the machine in general. Unlike the prototype, the claimed machine has no beams supporting the stamps laced with pneumatic drives; the beams are replaced by the manipulator. The manipulator, with its simple and compact design, allows stamps to move both horizontally and vertically related to the matrices on the conveyor. This ensures the simplicity and compactness of the machine, as well as provides the “manual baking” effect due to a one-time closing of the molds (in the prototype, stamps and matrices had to be coupled and decoupled 9 times during the baking process).

Operating reliability of the machine is ensured by exclusion of such mechanical parts as the beams, cartwheel pairs, and sliding contacts, i.e., the moving parts subject to friction and wear. The control unit is connected to the dispenser, chain conveyor drive, heating assemblies of the matrices and stamps, and the manipulator, the motion cycle of the latter being performed under commands from the control unit.

The specific aspect of one of the embodiments of variants 1 and 2 is that deformation of any heating assembly can be prevented by providing an external cooling system consisting of the upper and lower contours relative to the induction element wire. It is important that in each contour the cooling tube is put in turns similar to the induction element.

Also, the specific feature of another embodiment of variants 1 and 2 is that any heating assembly can be protected from deformation by providing an internal cooling system of the induction element. It is critical for any heating assembly to have its induction element (coil) made of a metal tube forming the contour of the cooling system inside the inner space of the tube.

Besides, particular embodiments of variants 1 and 2 of the pastry making machine demonstrate the following differences from the prototype.

The sliding rails moving the carriage with the dough dispenser are attached to the support frame of the conveyor; this reduces the size of the machine.

The dispenser has the same components as in the prototype and, depending on the product type, can be equipped with either a two-roll or a four-roll blower. The prototype had one drive for connecting the blower having one or two kinematic pairs of rolls.

However, a single drive of the two-roll-pair blower may—with uneven wear of roll surfaces—eventually require a replacement of the whole costly blower. The distinction of the claimed technical solution is that every kinematic pair of the blower rolls is independently connected to a separate drive. Connecting the kinematic pairs of the blower rolls to separate drives ensures even wear of roll surfaces; in case the wearing occurs, the quality of finished products can be maintained simply by increasing the dosage of the dough.

In the prototype, the dispenser is installed on a separate mobile frame, with considerable dispenser weight affecting the frame inertia and the machine performance. However, if the dispenser is installed on a massive support frame of the conveyor, this lack of inertia helps increase the speed of dispenser movements. Mounting the dispenser on the support frame also ensures simplicity and compactness of the machine.

The fact that each cart with the matrices installed thereon has the base with T-shaped bent edges in the front and the back and has one wheeled axle installed underneath the bent front part, offers the following advantage.

The cart is more lightweight, so upturning and shaking thereof causes less inertia moment; in its turn, this prevents threaded fittings of aluminum matrices from stripping. Reducing the number of components by having only a portion of wheeled axles allows for installing the carts in the direction of travel of the conveyor in such an order where a bent portion of a back part of one cart rests on a bent portion of a front part of another cart, thus making the machine more compact by shortening the linear distance between the axles.

In case the finished product turner and the excess remover are installed in front of the unloader, the turner slightly opens each stamp above a matrix from one side, then from the other. As the product is being peeled off from the stamp, the turner interacts with the baked product in the molds without damaging its integrity. Besides, as the forming of a dough product may cause excessive dough to get beyond the mold edges, the excess remover cuts the excesses of the baked products and thus helps calibrate every baked item.

The ensuing description is illustrated by the drawings and photos where:

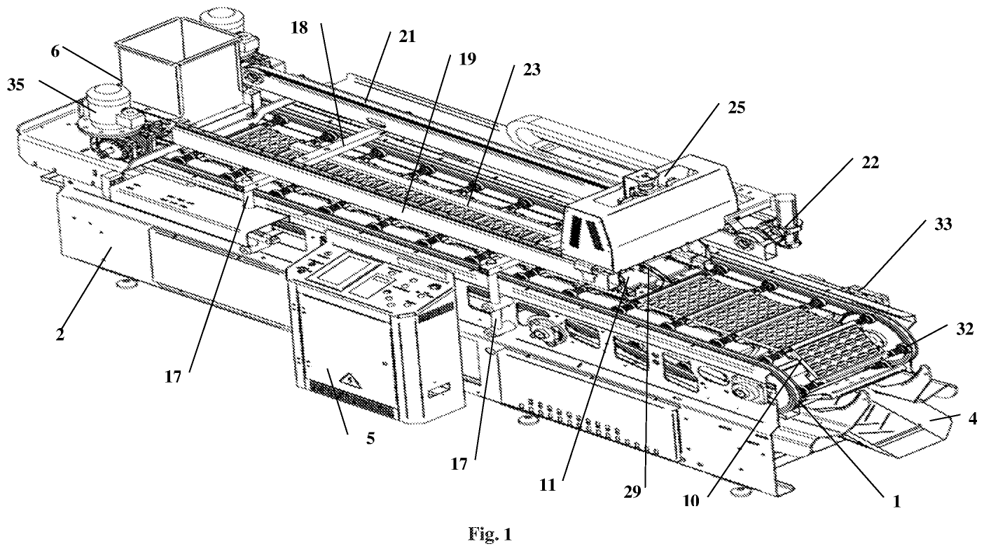

FIG. 1 demonstrates the pastry making machine from the control unit side;

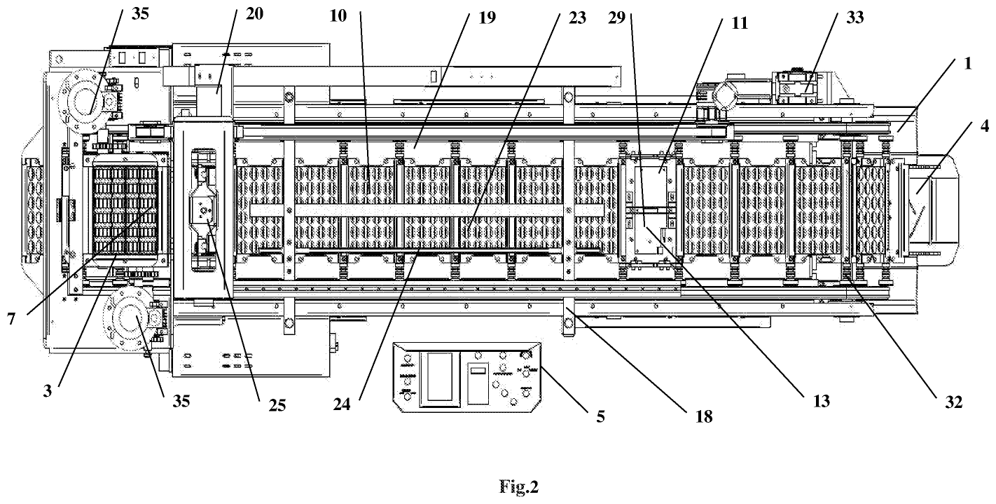

FIG. 2—top view;

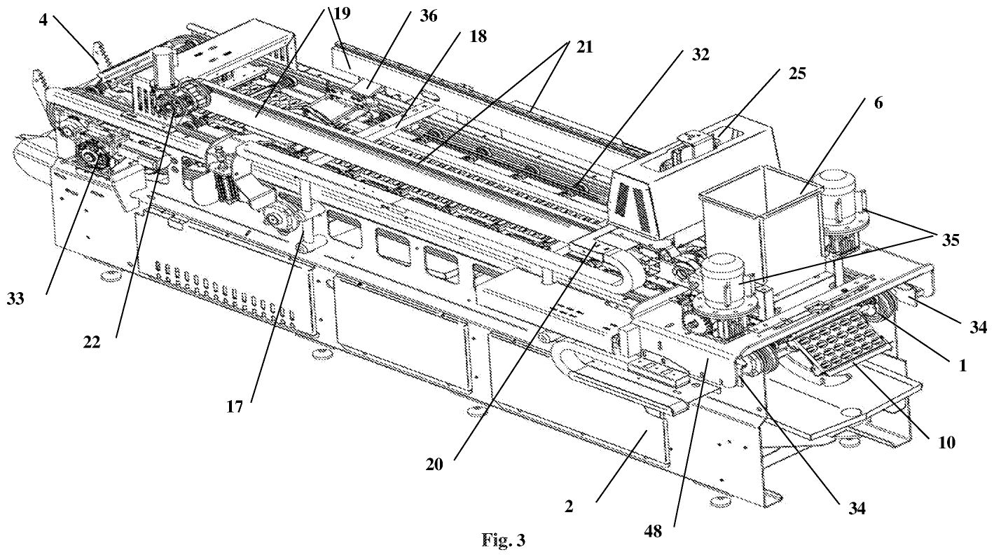

FIG. 3—the same, from the turner's side;

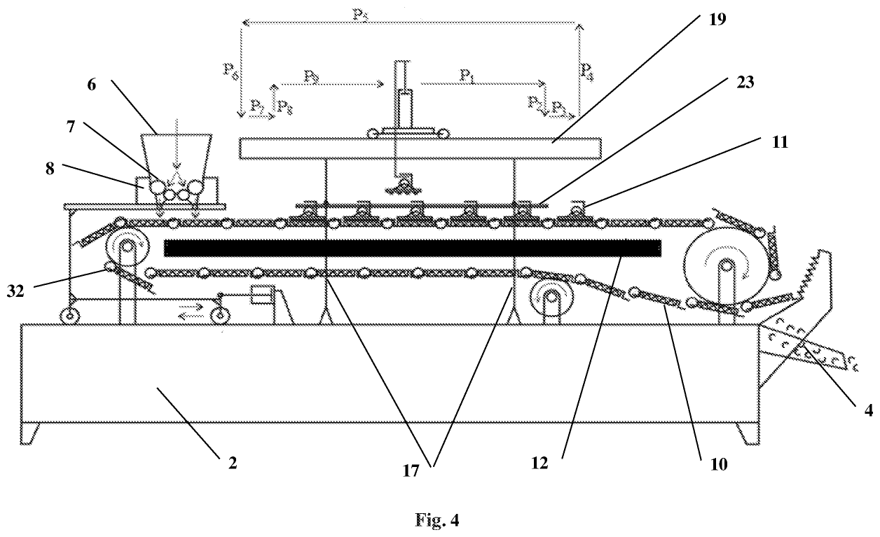

FIG. 4—the machine with one heating assembly, schematically;

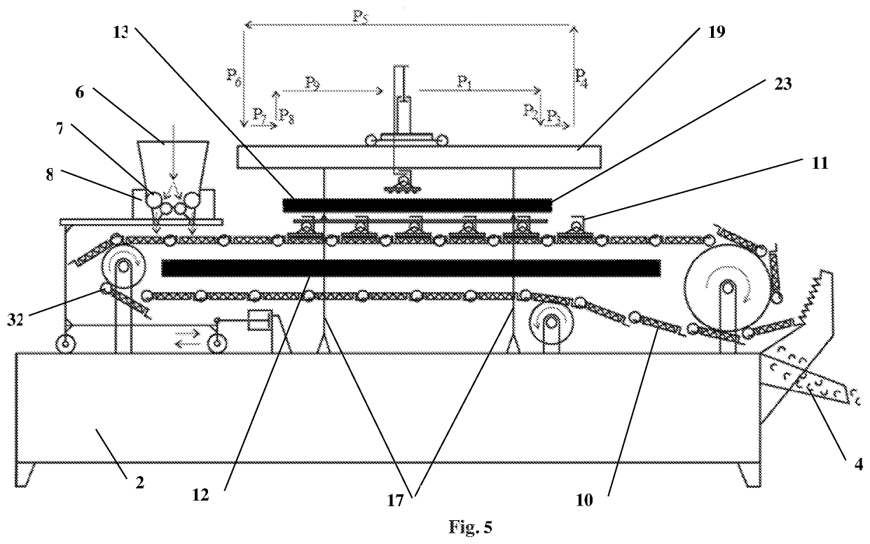

FIG. 5—the same, with two heating assemblies;

FIG. 6—same as FIG. 4, back view;

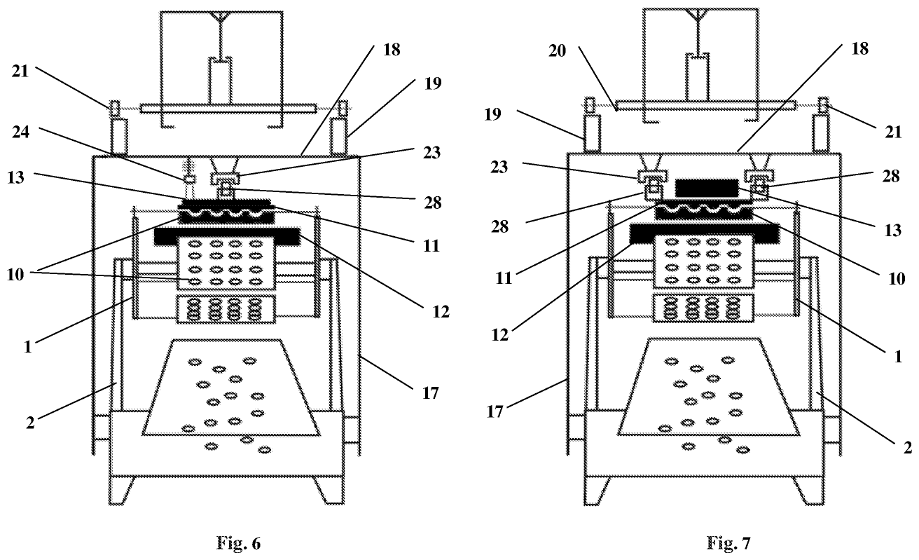

FIG. 7—same as FIG. 5, back view;

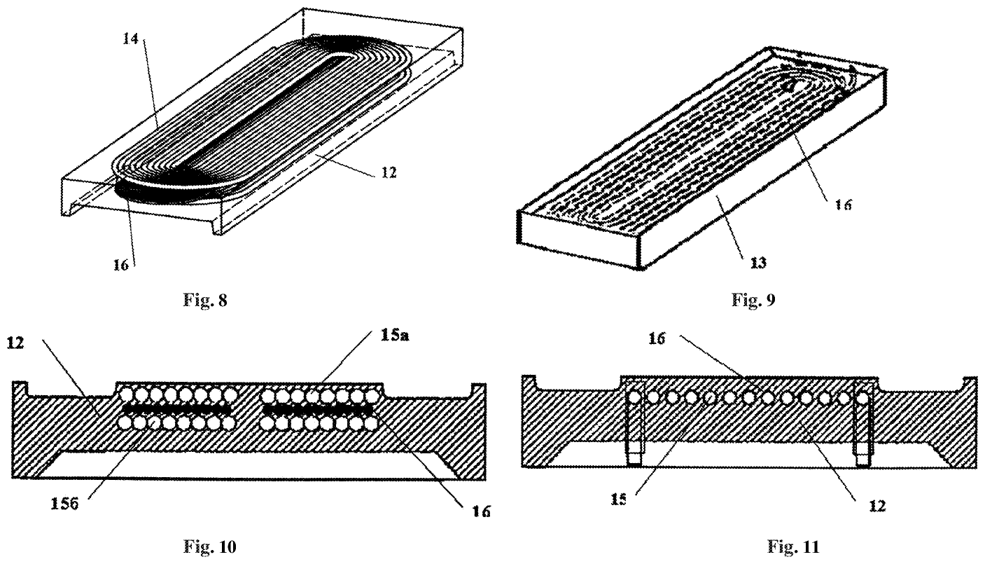

FIG. 8—the heating assembly for the matrices;

FIG. 9—the heating assembly for the stamps;

FIG. 10—the heating assembly with the two-contour coil cooling;

FIG. 11—the same, with the one-contour cooling system;

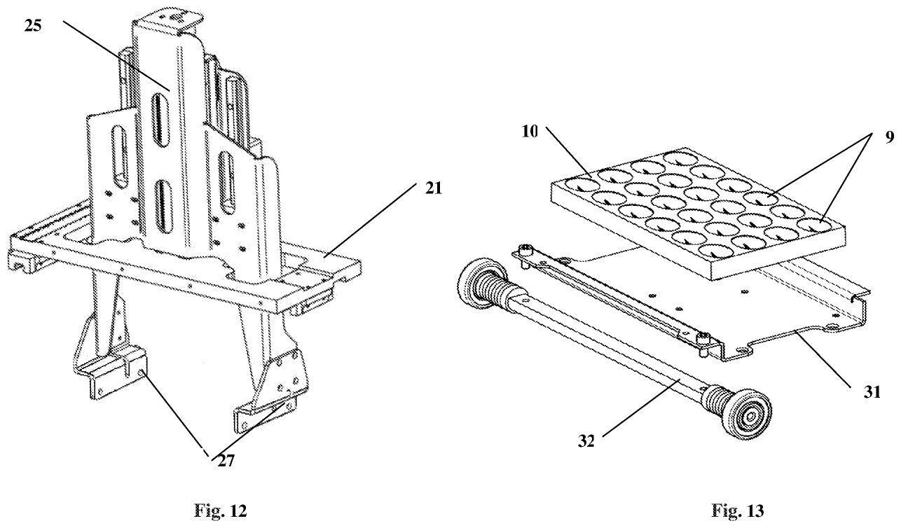

FIG. 12—the manipulator, general view;

FIG. 13—the matrix and the cart, disassembled;

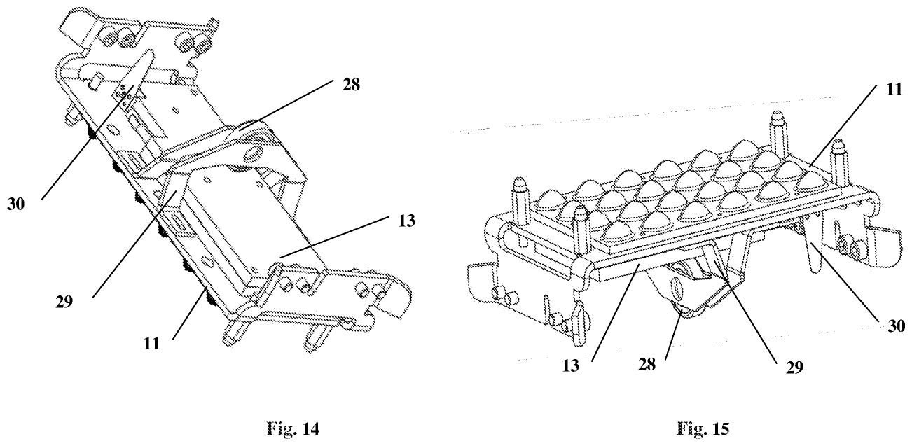

FIG. 14—the stamp with the pressing roll above;

FIG. 15—the stamp, bottom view;

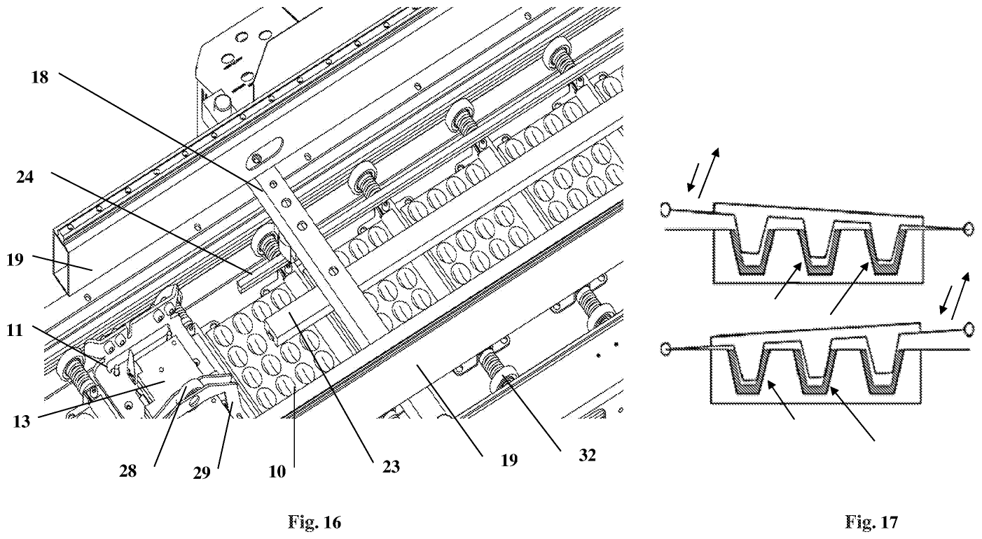

FIG. 16—the oven with the current-conducting profile;

FIG. 17—the turner's operating layout;

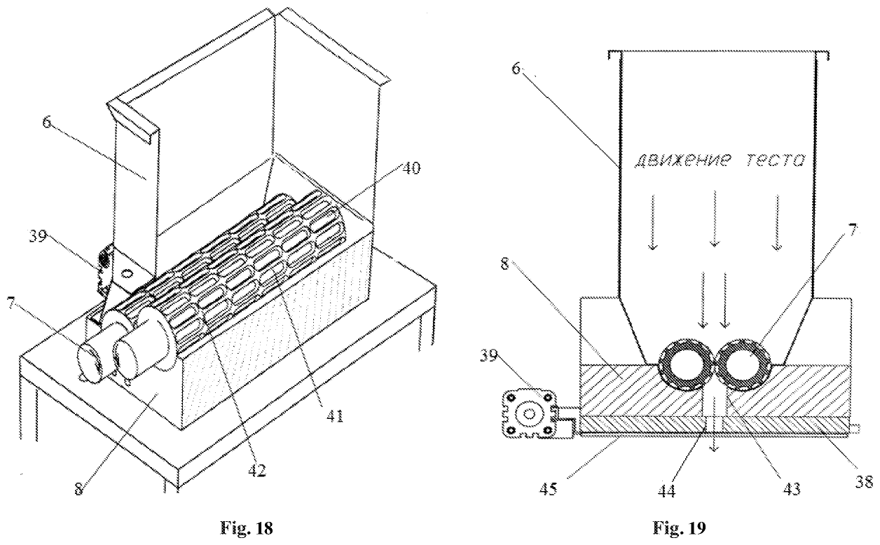

FIG. 18 shows a sectional view of the dispenser with one kinematic pair;

FIG. 19 illustrates how the dispenser with one kinematic pair operates;

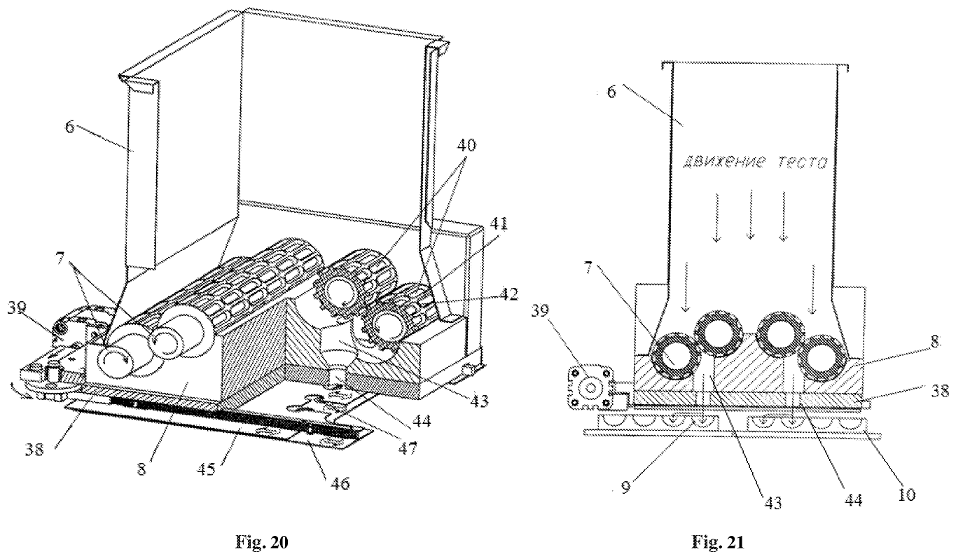

FIG. 20 shows a sectional view of the dispenser with two kinematic pairs; and

FIG. 21 illustrates how the dispenser with two kinematic pairs operates.

According to the general design, the pastry making machine (e.g., the first variant) comprises a transporter—a chain conveyor 1 attached to a support frame 2, an open conveyor oven for baking the product formed by a dough dispenser 3, a finished product unloader 4, and a control unit 5. The dough dispenser 3 is installed in the beginning of the conveyor 1 and is capable of reciprocal motion; the dispenser contains a hopper 6, a blower made of rolls 7 (as demonstrated by FIGS. 4, 5), a dosing head 8 equipped with a device discharging dosed dough. The surfaces of rolls 7 forming at least one kinematic pair are profiled with separating cells spaced apart from each other and forming longitudinal and transversal rows on rolls 7. Respective to those rows are rows of separating chambers on the surface of the dosing head 8. The rows of the separating cells and the separating chambers are designated as drawing positions 40 and 43, respectively, in FIGS. 18, 21. The structure of the dispenser will be described below in more detail.

Depending on the pastry product configuration, the conveyor 1 is equipped with molds 9, positioned in longitudinal rows on matrices 10. The number of rows of the molds 9 installed on the matrix 10 depends on the pastry product configuration and size. Smaller products require more rows on every matrix 10 than bigger products do. In that case, the dispenser 3 is equipped with the blower with four rolls forming two kinematic pairs. Stamps 11 are positioned according to the rows of the molds 9 installed on the matrices 10. The matrices 10 and the stamps 11 are equipped with heating assemblies 12 and 13, respectively. The unit 12 for heating the matrices is located underneath the conveyor 1, stretched along the whole oven, and attached to the brackets. Inside the heating assembly 12, there is an induction element 16 (coil) insulated with dielectric 14, with turns of the element 16 horizontally stretched along the unit 12; the induction element 16 is equipped with a water-cooling system 15.

In the oven area, II-shaped stands are installed above the conveyor 1, their vertical elements 17 are equipped with II-stand bars 18 and mounted on the support frame 2, on the sides of the conveyor 1. On the II-shaped stands and installed above the II-stand bars 18 are guide rails 19 with a platform 20. One of the guide rails 19 is equipped on its external side with a flexible arm of a toothed belt transmission 21, ball bearings and a drive 22. The II-shaped stands along the conveyor 1 help guide a supporting bar 23 and a conductive profile 24 installed below on the II-stand bars 18. The platform 20 is installed to be adapted for reciprocal motion along the guide rails 19 and has a manipulator 25 equipped with a lifting mechanism 26 and a magnetic or mechanical grippers 27 for the stamps 11.

Every stamp 11 (FIG. 14) is equipped with a pressing roll 28 mounted on a bracket 29, supported by the bar 23, as well as with a spring current-collecting contact 30 for connecting the heating assembly 13 to the current-conducting profile 24. The matrices 10 are made of aluminum and mounted on the wheeled carts. Each of the matrices 10 is attached to the steel base 31 of the cart; the cart is connected with the end parts of its front axle 32 to the chain conveyor 1 for upturning the cart and unloading the finished product from the oven (FIG. 13).

The control unit 5 is connected via sensors (not shown) with the dispenser 3, drive (gear motor) 33 of the conveyor 1, and the heating assemblies 12, 13 for the matrices 10 and the stamps 11, respectively; the unit 5 is regulated according to the position of the molds 9 on the matrices 10 and commands the motion cycle of the manipulator 25.

The general design of the pastry making machine according to variant 2 comprises the same components as the first variant, with the exception of the missing current-conducting profile 24; one heating assembly 13, positioned above the conveyor 1, is used for heating the stamps 11. Similar to the heating assembly 12, the unit 13 is stretched along the oven (FIG. 5, 7). Located inside the heating assembly 13 is the induction element (coil) 16 which is insulated with dielectric 14, equipped with the water-cooling system 15, and whose turns are horizontally stretched along the heating assembly 13.

Another difference is that the II-shaped stands along the conveyor 1 guide the bars 23, supported from underneath by the II-stand bars 18, while the heating induction unit 13 is installed between the supporting bars 23. To rest on the supporting bars 23, each of the stamps 11 is equipped with two pressing rolls 28; each of the rolls 28 is installed on the respective bracket 29 (FIG. 7).

The first particular embodiment of both first and second variants of the machine has the same components as the general design. The adjustment is that the water-cooling system 15 of the coil 16 wire has an upper and a lower contours with cooling tubes 15a and 15b respectively; the contours are laid in coiled turns similar to the wired induction element 16 (FIG. 10).

The second embodiment may have the water-cooling system 15 in the heating assembly 12 (variant 1) and in the heating assemblies 12, 13 (variant 2) single-contoured (FIG. 11). The induction element (coil) of the oven heating assembly 12 or units 12,13 is made of the metal tube forming inside itself an internal contour of the cooling system 15 for the induction element 16.

The third embodiment of both variants 1 and 2 comprises the same components of the pastry making machine as its general design. The adjustment is that the support frame 2 of the conveyor 1 has the guide rails 34 for moving the carriage with the dough dispenser 3, and any kinematic pair formed by rolls 7 in the dispenser 3 is connected by a drive 35 separately from the other kinematic pair (FIG. 1-3). The dispenser 3 installed on the support frame 2 has an additional degree of freedom, making it possible to regulate the height of the dough relative to the matrices 10.

The fourth embodiment of the pastry making machine in both variants comprises the same components as the general design, with the following adjustment: every aluminum matrix 10 is installed on the cart with the steel base 31 thereof having T-shaped bent edges in the front and in the back; the wheeled axle 32 (FIG. 13) of the cart is installed under the bent part of the front edge of the cart base. That said, the carts are installed in such an order in the direction of travel of the conveyor that the bent portion of the back part of a preceding cart rests on the bent portion of the front part of a succeeding cart under which part the wheeled axle 32 is fastened.

The fifth embodiment of the pastry making machine for both variants comprises the same components as the general design, with the following adjustment: the machine is equipped with a finished product turner 36 and an excess remover 37, which are located sequentially in front of the unloader 4 and installed on the support frame 2 of the conveyor 1 (FIG. 3).

The pastry making machine made according to, for example, variant 1 of the general design, operates as follows.

First, the oven is launched before the dosed dough pieces are put into the molds 9 on the matrices 10 (FIG. 13). The drive 33 of the conveyor 1 is switched on; once the grounding contour is checked, water is supplied to the cooled contours 15a, 15b of the unit 12. When the oven is launched, the matrices 10 and the stamps 11 are heated to the preset temperature via the induction elements 16 of the heating assemblies 12 and 13, respectively. Voltage is supplied to the heating assembly 13 of the stamps 11 via the current-collecting contacts 30, connected to the respective current-conducting profile 24 (FIG. 16). Simultaneously, dough is being loaded to the hopper 6 of the dispenser 3.

In the manual mode, it is necessary to check the dough evenness and stability of its discharge through the separating chambers of the dosing head 8. The idle cycle of opening/closing the stamps 11 and the matrices 10 is run using the manipulator 25.

When the temperature of the matrices 10 and the stamps 11 reaches 160-180ºC, the sample product is baked; depending on the sampling results, the baking temperature and dough dosage are adjusted. After those oven launching operations are complete, pieces of dough are prepared in the dispenser 3.

Dough is supplied to the dispenser 3 via the hopper 6. The rolls 7 of the kinematic pair of the blower start counterrotating guided by the drive 35 and gear engagement of the rolls. As illustrated by FIGS. 18, 19, the rolls 7 are profiled by the rows of the separating cells 40 and are installed “tooth-in-tooth”. In the process of the counter-rotation with a clearance of 0.015 mm from the surface of the dosing head 8, the rolls 7 carry off dough which, by means of strips 41 of the cells 40, is drawn in between the rolls 7 and divided into flow streams by means of strips 42.

The dough divided into the streams is squeezed into the separating chambers 43 aligned in the dosing head 8. As the dough is pressed through the separating chambers 43, separate dough pieces are formed and then squeezed out through calibrating channels 44 on a forming bed 38. Then, as will be described below, the dough pieces are cut off.

Shown in FIGS. 20, 21, the dough dispenser with two pairs of the rolls 7 operates in such a way that the counter-rotation of each pair of rolls 7 is carried out by engaging rolls between each other. In each kinematic pair, the dough, engaged with the rows of the separating cells 40 and strips 41 and 42 made on the rolls 7, is divided into the flow streams and squeezed into rows of the separating chambers 43 in the dosing head 8. With that, the dough streams formed by each pair of the rolls 7 are directed into those separating chambers in the dosing head 8 which are in the row corresponding to that pair.

The dough pieces formed in each row of the separating chambers 43 are squeezed out through the calibrating channels 44, which are in line with the chambers 43 and located in rows on the forming bed 38, and then through outlets 47 which are in line with the channels 44. The discharge of the dough pieces from the dispenser into the molds is carried out by counter motion of blade plates 45, 46. Forced by a drive 39, the blade plates 45, 46 overlap the rows of the outlets 47 (FIG. 20) to thus cut off the dough pieces. After that, the blade plates 45, 46 are repositioned back restoring communication between the outlets 47 and the calibrating channels 44 of the forming bed 38.

In particular cases, where the dough dispenser comprises the separating chambers 43 of the dosing head 8 which have a tapering-down conical form, or a composite form, the dispenser operates generally in the same manner, the difference being the increased efficiency of dosing, when the dough pieces move from the chambers 43 into the channels 44, due to the absence of no-flow zones.

In the particular case, where the longitudinal rows of the separating cells in one kinematic pair of the rolls 7 have, in relation to the longitudinal rows of the separating cells in another kinematic pair of the rolls 7, a regular or a staggered order, filling the molds 9 is carried out in the next but one row.

However, when the rows of the separating cells on the rolls of the different kinematic pairs are arranged in the staggered order relative to each other, it becomes possible to use more molds at the same area and, thus, to make the dispenser more efficient and reduce energy usage.

When the pieces of dough are measured in the separating chambers 43, cut off from the dispenser 3 and put into the molds 9 the conveyor does not move.

While the molds 9 are being filled, only the carriage 48 with the dispenser 3 is in motion; its movement depends on the number of rows on the matrix 10. E.g., if the matrix 10 has three rows of molds, the carriage 48 with the dispenser 3 makes three moves. The dispenser 3, for which one kinematic pair of rolls 7 suffices, successively fills the first row of the molds 9, then the second and the third rows.

If the matrices 10 have four rows of the molds 9, the molds are filled with dough by means of rotation of four rolls 7 forming two kinematic pairs. The molds 9 are being filled in the next but one row on the same matrix or on two adjacent matrices 10 placed under the dispenser 3 {see FIG. 21). In this case, only one half of the first matrix, if it has more than three rows of molds, is filled with the dough, i.e., only the last two rows are filled. At the same time, the dough is being put into the 3^{rd} row of the molds 9 of the first matrix 10 placed under the dispenser 3, and into the 1^{st} row of the molds 9 located on the second matrix 10. As the carriage with dispenser 3 moves one step, the 4^{th} row of the molds 9 on the first matrix 10 standing under the dispenser and the 2^{nd} row of the molds 9 on the second matrix 10 are being filled simultaneously. Then the control unit 5 stops the filling by the dispenser 3, the conveyor 1 moves the half-loaded matrix 10 towards the oven and stops.

As the half-loaded matrix 10 is moving towards the oven, the dispenser 3 does not move and does not discharge the dough. When the oven starts working, the conveyor 1 being stopped at this time, the manipulator 25 via the platform 20 and the guide rails 19 (one of the rails 19 is equipped with the arm of the tooth-belt transmission 21 and the drive 22) makes the process step P₁ (FIG. 4) for removing the stamp 11 from the matrix 10 that has left the baking area. Via the lifting mechanism 26 of the manipulator 25, the grippers 27 move downwards to the stamp 11 on the matrix 10 (the process step P₂, FIG. 4), and the stamp 11 is taken off the matrix 10 (the process step P₃). Then, the manipulator 25 lifts the stamp 11 (the process step P₄) and transports it along the conveyor 1 towards the dispenser 3 and the opening of the oven (the process step P₅). The grippers 27 holding the stamp 11 (the process step P₆) move downwards, and the stamp 11 is installed on the dough-filled matrix 10 that has moved from under the dispenser 3. As the stamp 11 closes the matrix 10, it gives the dough in the molds 9 the shape of the finished product. The gear motor 33 switches on the conveyor 1 for transporting the molds 9 on the matrix 10, covered by the stamp 11, to the oven. By that time, as the dispenser performs a step, and the rows left unfilled are filled making the matrices 10 fully filled. The grippers 27 of the manipulator 25, pressing the stamp 11 against the matrix 10, prevent it from opening as dough rises. The manipulator 25, holding the stamp against the matrix with the grippers 27, takes the stationary position, and the transfer thereof in the process step P₇ takes place as the conveyor 1 with the matrices 10 on makes a step motion. As the conveyor 1 is in the step motion (the process step P₇, FIG. 4), the manipulator 25 keeps its stationary position until the moment where the roll 28 on the stamp 11 is positioned underneath the supporting bar 23 on the II-stand bars 18 of the conveyer 1. Once the conveyor 1 completes its step, it stops; the lifting mechanism 26 of the manipulator 25 switches on, the grippers 27 stop holding the stamp 11 as they make the process step P₈ upward. The stamp 11 is now pressed to the matrix 10 by the roll 28 that slides along the bar 23 during the following steps made by the conveyor 1. As, during the process step P₈, the grippers 27 of the manipulator 25 are being lifted, the manipulator 25 via the platform 20 and using guide rails 19 makes the process step motion P₉-P₁ along the conveyor 1 towards the matrix 10 with the stamp 11 that are moving from the oven. The grippers 27 move downwards to that stamp 11 via the mechanism 26 of the manipulator 25. The gripped stamp 11 is lifted upwards and transported to the opening of the oven; then, it is put downwards and covers another filled matrix 10. The conveyor 1 switches on and moves the matrix 10 covered by that stamp 11 towards the baking area; in the end of the baking area, the matrix 10 with the baked product and covered by the stamp 11 moves out of the oven. The process (with the steps Pᵢ) described above is repeated. During the movements of the manipulator 25 and its components at the process steps P₁-P₆, P₈ and P₉-P₁, the conveyor 1 chain is stationary; it is only during the process step P₇, when the manipulator 25 is stationary, that the conveyor 1 moves one step.

As the matrices 10 are transported out of the oven and opened one by one with the assistance of the manipulator 25, the conveyor 1 transports them stepwise to the finished product unloader 4. As the moving chain of the conveyor 1 reaches the drive wheel of the conveyor 1, each cart on the chain with the matrix 10 mounted on its base 31 is upturned. When it hits the limiter of the unloader 4 (the console installed on the frame 2), each of the matrices 10 is shaken and the finished product is unloaded from the molds 9. When the conveyor 1 chain goes round the drive wheel, every upturned cart with the matrix 10 on, attached with its front axle 32 to the conveyor 1 chain, comes back to the conveyor. As it makes its steps, the conveyor 1 chain transports the sequentially unloaded matrices 10 back to the dough dispenser 3 where, with the conveyor 1 stopped, the molds 9 on two adjacent matrices 10 under the dispenser 3 are filled again. As the conveyor 1 moves one step, the next matrix 10 with its molds 9 filled with the dough is transported from the dispenser on the wheeled cart. Thus, the motion cycle of the dispenser 3, conveyor 1, and manipulator 25 is repeated.

The control unit 5 of the machine operates as follows. An electronic controller puts carts with the matrices 10 on the conveyor 1 into motion and stops them. The carts with the mold-containing matrices 10 mounted on the bases 31 are upturned via the programmed shaking of the matrices as they hit the unloader 4 limiter designed as the console installed on the frame 2. The positioning and movement of the stamps 11 are controlled by the contact-free sensors (not shown) and is operated by the manipulator 25. The heating assembly 12 of the matrices 10 and the heating assemblies 13 of the stamps 11 are switched on and off following the commands from the control unit 5. The control unit 5 also sends commands for moving the dispenser 3 carriage and positioning it relative to the matrices 10 as they are loaded.

If the heating assembly 12, equipped with the two-contoured cooling system 15 with the tubes 15a, 15b coiled similar to the induction element 16, is in the oven, then the assembly 12 is protected from overheating via the cooling liquid transported through the tubes of the contours 15a and 15b, i.e., above and under the wired coil 16.

In the particular case where the induction element 16 of the heating assembly 12 is made of a metal tube, the liquid protecting the unit 12 from overheating is transported through the internal space of said metal tube.

In the particular case where the kinematic pairs of the rolls 7 in the dispenser 3 is equipped with the separate drives 35 (FIG. 3), the pastry making machine operates similarly to the general design. The exception is that the amount of the discharged dough is proportional to the rotation angle of the respective drive 35. The rotation angle of the drive 35 is being monitored by the special sensor (not shown). Each rotation angle of the rolls 7 of the dispenser 3 corresponds to a specific number of sensor impulses, monitored by the computer. Thus, the dosage of the dough that fills the mold 9 depends on the number of impulses preset by the operator on the control unit 5 panel.

In the particular case where the guide rails 34 for moving the carriage with the dispenser 3 are located on the support frame 2, the sequence of configuring and launching the dispenser 3 is as follows. First, the oven is heated, then the control unit 5 gives the command to start forming the dough pieces in the dispenser 3 for further discharging them into the molds 9 on the matrices 10. The dispenser installed on the support frame 2 is provided with an additional degree of freedom, making it possible to regulate the height of the dough pieces and improve their positioning relative to the molds 9 on the matrices 10 while also increasing the motion speed of the dispenser 3.

In case of a particular embodiment of the pastry making machine where every matrix 10 is installed on the cart base 31 with T-shaped bent edges in the front and in the back and the wheeled axle 32 is positioned under the bent front part, induction currents have the maximum effect on the matrices 10.

As the cart bases 31 have I-shaped bent edges in the front and in the back, the matrices 10 are located below the wheeled axle 32, as close to the heating assembly 12 as possible. Hence, the impact of induction currents on the axle 32 itself (idle heating) is reduced. When the carts are moving back after unloading the matrices 10, the fat build-up on the surfaces of the matrices is partially scraped off, and the matrices get partially cleaned.

In case a particular embodiment of the machine is equipped with the finished product turner 36 and the excess remover 37, the machine operates similarly to its general design. However, to prevent the products baked in the molds 9 from sticking to the stamps 11, the matrices 10 covered by the stamps 11 get partially opened in turn from their opposite sides (FIG. 17) by the turner 36. This reduces the fat adhesion that appeared during the baking on every matrix 10, while the baked products stay in the molds 9 and remain intact.

After that, the manipulator 25 successively removes the stamps 11 from all matrices 10 as they are being transported out of the oven. Having their stamps 11 taken off, the matrices 10 move towards the excess remover 37. By calibrating every baked product, e.g., with a profiling tool (cutter) with preset geometry, excesses are removed from the items. The motion of the cutter is regulated, and, when it moves downwards to the matrix 10 containing the baked products, its cutting edge does not contact the mold-forming matrix 10. After removing the excesses, the cutter stops directly in front of the matrix 10. Then, every matrix 10 moves towards the unloader 4. As the matrix 10 hits the limiter of the uploader 4, it is shaken, and the products drop out of the matrix.

The claimed machine can be assembled from fabricated parts, units, and assemblies using the conventional materials, fixtures, and technologies. For making the invented machine, commonly applicable construction assemblies, components, elements, and materials can be used, including hydraulic elements, rubber items, and fixture elements. For example, heating elements of the stamps can be made of aluminum plates with contacts soldered thereto. Flexible heat-resistant wires can be used for powering the heaters. The temperature of heating the baking surfaces can be adjusted with voltage regulators. The pastry making machine can be equipped with a computer control unit, such as OMRON CP1E-N30DT-D with an extension module.

1. A pastry making machine comprising:
a transporter attached to a support frame and including a chain conveyor with a drive and product molds positioned in longitudinal rows on matrices,
a dough dispenser positioned at the beginning of the conveyor, capable of reciprocal motion and comprising a dosing head and a hopper connected to the dosing head,
stamps located in compliance with the rows of the molds on the matrices,
an open conveyor oven for baking the pastry,
a finished product unloader,
a blower including rolls forming at least one kinematic pair, surfaces of the rolls being profiled with separating cells distanced from one another and forming longitudinal and transversal rows,
at least one row of separating chambers is made in the dosing head in accordance with the separating cell rows and are joined with the channels discharging the dough pieces,
Π-shaped stands installed in the oven area above the conveyor, vertical parts of the Π-shaped stands being located on the sides of the conveyor support frame,
guide rails located on upper Π-stand bars and supporting a platform,
a manipulator supported by the platform and equipped with a lifting mechanism and stamp grippers, and
a control unit connected to the dispenser, the manipulator and the conveyor drive,
the matrices installed on the conveyor and the stamps installed at the open oven and adapted for vertical motion for covering/uncovering the matrices being equipped with heating assemblies located above and underneath the conveyor, respectively,
the heating assemblies being connected to the control unit,
every matrix being installed on an integral base of a wheeled cart attached to the chain conveyor with end parts of a front wheeled axle thereof for upturning and unloading the finished product transported from the oven,
the heating assembly located under the conveyor including a unit stretched along the oven, installed on a brackets and equipped with a dielectric-insulated induction element including a coil having horizontally stretched turns inside the unit, and with a
water cooling system,
a supporting bar orientated along the conveyor and a current-conducting profile being located under the upper Π-stand bars,
the platform being adapted for a reciprocal motion by means of a toothed belt transmission installed on the external side of one of the guide rails;
every stamp being equipped with a pressure roll installed on a bracket to be supported by the supporting bar and with a current-collecting spring contact for connecting the heating assembly to the current-conducting profile.

2. The machine as claimed in claim 1 wherein the cooling system comprises upper and lower contours, cooling tubes of said contours being put in coils similar to the induction element.

3. The machine as claimed in claim 1, wherein the induction element includes a metal tube forming an internal contour of the cooling system.

4. The machine as claimed in claim 1, wherein the dough dispenser is mounted on the support frame of the conveyor, the support frame being equipped with the sliding rails for moving a carriage with the dispenser.

5. The machine as claimed in claim 1, wherein each kinematic pair of the blower rolls in the dispenser is equipped with a separate drive.

6. The machine as claimed in claim 1, wherein every matrix has Γ-shaped bent edges in the front and in the back thereof.

7. The machine as claimed in claim 1 wherein a finished product turner and a excess remover are positioned in front of the unloader.

8. A pastry making machine comprising:
a transporter attached to a support frame and including a chain conveyor with a drive and product molds positioned in longitudinal rows on matrices,
a dough dispenser positioned at the beginning of the conveyor, capable of reciprocal motion and comprising a dosing head and a hopper connected to the dosing head,
stamps located in compliance with the rows of the molds on the matrices,
an open conveyor oven for baking the pastry,
a finished product unloader,
a blower including rolls forming at least one kinematic pair, surfaces of the rolls being profiled with separating cells distanced from one another and forming longitudinal and transversal rows,
at least one row of separating chambers is made in the dosing head in accordance with the separating cell rows and are joined with the channels discharging the dough pieces,
Π-shaped stands installed in the oven area above the conveyor, vertical parts of the Π-shaped stands being located on the sides of the conveyor support frame,
guide rails located on upper Π-stand bars and supporting a platform, located under the upper bars are supporting bars orientated along the conveyor and a heating induction unit located between the supporting bars,
a manipulator supported by the platform and equipped with a lifting mechanism and stamp grippers, and
a control unit connected to the dispenser, the manipulator and the conveyor drive,
the matrices installed on the conveyor and the stamps installed at the open oven and adapted for vertical motion for covering/uncovering the matrices being equipped with heating assemblies located above and under the conveyor, respectively,
the heating assemblies being connected to the control unit,
every matrix being installed on an integral base of a wheeled cart attached to the chain conveyor with end parts of a front wheeled axle thereof for upturning and unloading the finished product transported from the oven,
the heating assemblies including units stretched along the oven, one unit being installed on brackets under the conveyor and the other—above the conveyor, a dielectric-insulated and equipped with a water cooling system induction element being located within every unit, the induction element including a coil with horizontally stretched turns,
the platform is capable of reciprocal motion along the guide bars equipped from external sides with flexible arms of toothed belt transmissions and a drive; every stamp is equipped with pressing rolls installed on brackets attached to the support bars.

9. The machine as claimed in claim 8 wherein the cooling system in any heating assembly comprises upper and lower contours, cooling tubes of said contours being put in coils similar to the induction element.

10. The machine as claimed in claim 8, wherein the induction element in any heating assembly includes a metal tube forming an internal contour of the cooling system.

11. The machine as claimed in claim 8, wherein the dough dispenser is mounted on the support frame of the conveyor, the support frame being equipped with the sliding rails for moving a carriage with the dispenser.

12. The machine as claimed in claim 8, wherein each kinematic pair of the blower rolls in the dispenser is equipped with a separate drive.

13. The machine as claimed in claim 8, wherein every matrix has Γ-shaped bent edges in the front and in the back thereof.

14. The machine as claimed in claim 8 wherein a finished product turner and a excess remover are positioned in front of the unloader.
